(19) United States
(12) Patent Application Publication
(10) Pub. No.: US 2019/0131672 A1
(43) Pub. Date: May 2, 2019

(54) HIGH POWER BATTERY MODULES WITH PCB SENSING ASSEMBLY

(71) Applicant: Lithos Energy, Inc., Sausalito, CA (US)

(72) Inventors: Erik Stafl, San Francisco, CA (US); James Meredith, Corte Madera, CA (US); David Kirkland, San Francisco, CA (US)

(21) Appl. No.: 16/177,786

(22) Filed: Nov. 1, 2018

Related U.S. Application Data
(60) Provisional application No. 62/580,301, filed on Nov. 1, 2017.

(51) Int. Cl. H01M 10/48

(52) U.S. Cl. CPC H01M 10/486; H01M 2220/20

(57) ABSTRACT

An assembly for monitoring the operation of a large format battery module. Printed circuit boards may be routed within a battery module to electrically interconnect collector structures with a battery module monitoring circuit. Flexible printed circuits (FPCs) may be wrapped around one or more sides of a battery module and secured to it, such as via adhesive. Voltage monitoring FPCs may be applied to one or more side surfaces to electrically interconnect battery module collector structures with a monitoring circuit. Temperature monitoring FPCs may interconnect temperature sensors with the monitoring circuit. In some embodiments, one or more serpentine PCBs may be installed in a central channel between cells beneath a plurality of collector structures. The collector structures may include extensions overlaying the serpentine PCBs for direct welding to a steel pad on one of the serpentine PCBs.

RELATED APPLICATIONS AND CLAIM OF PRIORITY

This patent application claims priority to U.S. provisional patent application 62/580,301, titled HIGH POWER BATTERY MODULES WITH FLEXIBLE PCB SENSING ASSEMBLY, which was filed on Nov. 1, 2017.

### TECHNICAL FIELD

The present disclosure relates in general to large format battery packs, and in particular to the use of PCB assemblies in battery modules for voltage and temperature sensing.

### BACKGROUND

As battery cell technology and manufacturing capacity improves, electric battery cells are increasingly combined in large format battery packs for high power applications. For example, high-power yet cost-effective battery packs are critical to the commercial viability of electric cars and other motive applications that may have traditionally been powered by non-electric means.

One popular approach for battery packs to generate high power output levels is to combine very large quantities of small battery cells into a large format battery pack. Dozens or hundreds of cells may be combined to deliver significantly higher levels of voltage and current output. The small-format cells may be produced in very high volume and very cost-effectively, with the failure or capacity degradation of any individual cell may have very limited impact on the performance of the pack as a whole. For these and other reasons, such large cell count battery packs have become a predominant approach for high-power applications such as electric cars.

Battery pack construction requires balancing of competing concerns. Size and weight are preferably minimized, while output power is maximized. However, the resulting high cell density presents challenges in monitoring temperature and voltage levels within the pack. Cost and ease of manufacturing may be of vital importance. Many applications also require high levels of reliability, even while subjected to mechanical vibration and varying ambient environmental conditions. In view of these and other factors, battery module design improvements may be particularly valuable.

### SUMMARY

The present disclosure describes constructions for battery modules and battery module monitoring assemblies, as well as methods for manufacturing and using such modules and assemblies. Embodiments may enable distributed monitoring of battery module operation (such as voltage and temperature levels), with negligible impact on module size and minimal assembly requirements.

In accordance with one aspect, a battery module may be formed from a plurality of battery cells installed within a cell retention frame. The battery module may include a plurality of collector structures electrically interconnecting subgroups of battery cells. The collector structures may be arranged proximate a top side and a bottom side of the module, and may be formed from conductive plates. A battery management circuit may include voltage monitoring circuitry and/or temperature monitoring circuitry, and may be included on a printed circuit board (PCB) which may be secured to a side surface of the module.

One or more flexible printed circuits (FPCs) may be utilized to electrically interconnect the battery management circuit with the collector structures, e.g. for monitoring voltage levels at the collector structures. In some embodiments, monitoring FPCs may be wrapped around left and right sides of the battery module, and secured thereto via adhesive applied to one side of each FPC. Collector plates proximate top and bottom sides of the module may include voltage monitoring tabs extending laterally from the collector plates, extending towards a module centerline such that they overlap, and are soldered to, conductive pads on the monitoring FPCs.

The monitoring assembly may also include temperature monitoring extensions formed from FPCs and extending over top and bottom surfaces of the battery module. The temperature monitoring extensions may include temperature sensors, and may be interconnected with monitoring FPCs mounted along module side surfaces, through which temperature sensor signals may be conducted to the battery management circuitry.

In some embodiments, one or more sensing PCBs may be inset within a central channel in the battery module. When, for example, cylindrical cells are arranged in staggered offset rows, one or more serpentine sensing PCBs may be secured within the central channel, between the cells, and inside top and bottom collector structures such as collector plates. Each collector plate may include a connecting tab overlying a steel pads on one of the sensing PCBs, such that the connecting tab and steel pad may be welded or otherwise electrically interconnected, preferably using a welding or interconnection operation that is also used to interconnect one or more battery cells with the collector plate.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE FIGURES

FIG. 1 is a top plan view of a battery module.

FIG. 2 is a top plan view of a battery module, with collector plates.

FIG. 3 is a bottom plan view of a battery module, with collector plates.

FIG. 4 is a top perspective view of a battery module, with collector plates.

FIG. 5 is a partial elevation of monitoring FPCs and collector interconnects.

FIG. 6 is a partial top perspective view of a battery module with monitoring FPCs and temperature sensing extension FPCs.

FIG. 7 is a top plan view of battery cells arranged in staggered offset rows with a serpentine PCB sensing assembly within a central channel.

FIG. 8 is a partial perspective view of the cells and serpentine sensing PCB arrangement of FIG. 7.

FIG. 9 is a partial top perspective view of a portion of a battery module with collector plate connecting tabs overlying a serpentine sensing PCB.

FIG. 10 is a cross-sectional slice elevation of battery cells interconnected with top side and bottom side collector plates, with upper and lower sensing PCB assemblies within a central channel.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

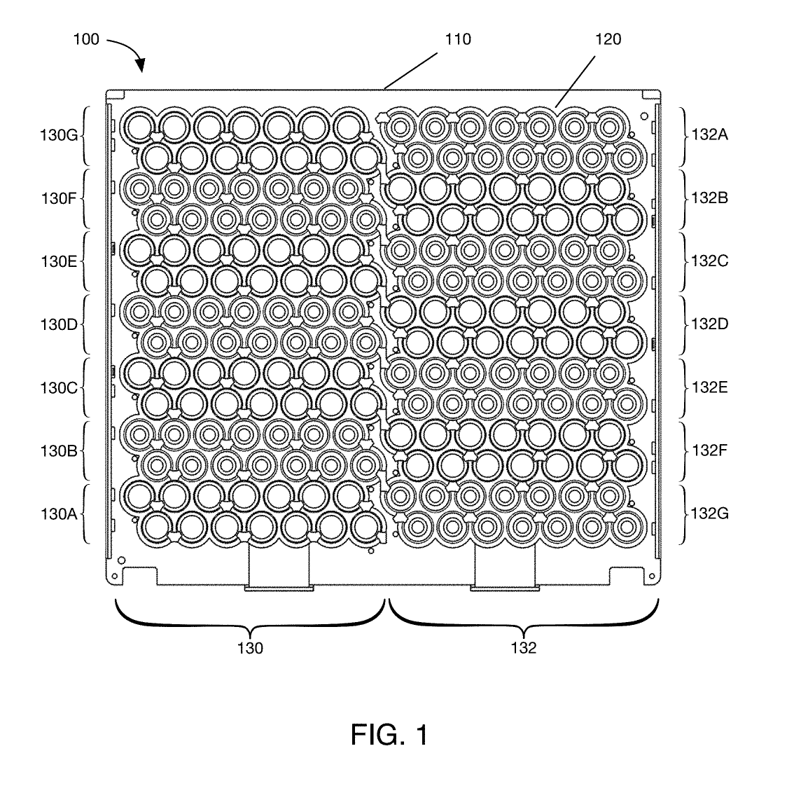

FIG. 1 illustrates an exemplary battery module structure that may be utilized to implement high-power, easy-to-manufacture, space-efficient battery packs. Battery modules such as illustrated in FIG. 1 may be utilized alone, or in packs formed from multiple interconnected modules. Combining multiple modules into a battery pack can provided high levels of configurability, reusing common parts to meet a wide variety of pack output requirements and other specifications. Combining multiple modules may also provide for form factor flexibility, safety and fault-tolerance. However, particularly in a multiple-module configuration, module compactness, manufacturability and operational monitoring may be very important.

To that end, battery module 100 includes battery cell retention frame 110. Cell retention frame 110 serves to, amongst other things, help physically orient and retain a number of battery cells 120 relative to the battery module as a whole. Typically, battery cells 120 are cylindrical in shape, and oriented with their longitudinal axes parallel to one another and the cells aligned such that the cell ends occupy common planes. FIG. 1 is a top plan view, with cylindrical battery cells 120 oriented vertically and parallel to one another. Cells 120 may be arranged in repeating groups having alternating orientations i.e. polarity. The group size may be varied to achieve various design specifications, such as current output and voltage level. For example, module 100 features cells 120 arranged in left grouping 130 and right grouping 132. Left subgroups 130A, 130C, 130E and 130G feature fourteen cells arranged in two rows of seven, with upward-facing cathodes. Left subgroups 130B, 130D, and 130F also feature fourteen cells arranged in two rows of seven, but are oriented with opposite polarity, i.e. with anodes facing upward. Analogously, right grouping 132 features subgroupings 132A, 132C, 132E and 132G with upward-facing anodes, while subgroups 132B, 132D and 132F are oriented with opposite polarity, i.e. upward-facing cathodes.

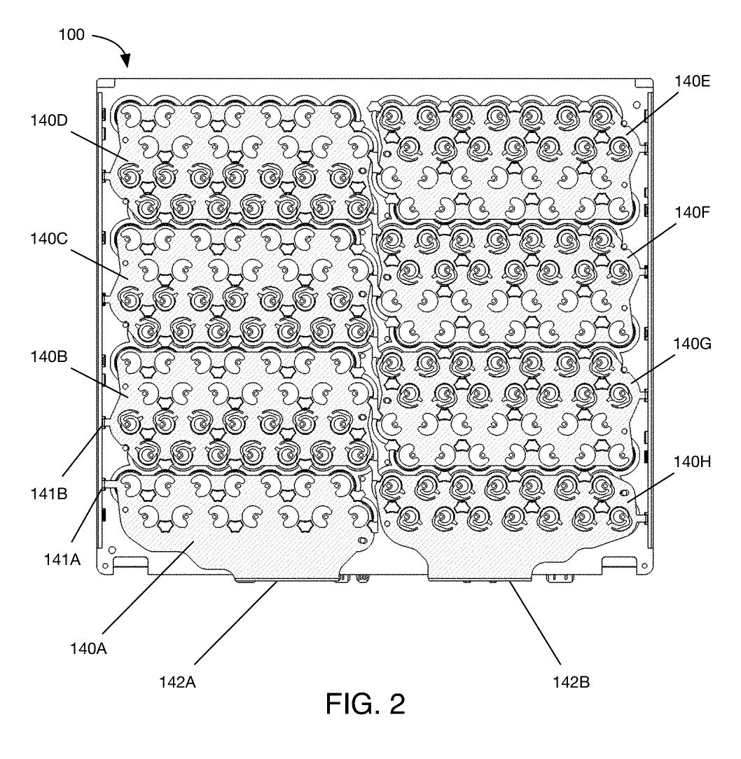

The battery module also includes conductive collector structures for electrically interconnecting subgroups of cells to one another. For example, relatively flat, conductive collector plate structures may be advantageously utilized to interconnect cells 120 in the arrangement of FIG. 1. FIG. 2 illustrates the battery module of FIG. 1, with collector plates applied thereto. Collector plates may be utilized to interconnect the anodes of one battery subgroup, with the cathodes of a neighboring battery subgroup. For example, in FIG. 2, collector plate 140A interconnects the cathodes of battery subgroup 130A with a module output terminal 142A. The anodes of battery subgroup 130A are electrically connected with the cathodes of battery subgroup 130B via a collector plate on the bottom side of module 100 (not shown). The anodes of battery subgroup 130B are electrically connected with the cathodes of battery subgroup 130C by collector plate 140B. Similarly, each of collector plates 140C, 140D, 140E, and 140F serve to electrically connect the anodes of one battery cell subgroup with the cathodes of a neighboring battery cell subgroup. In addition to interconnecting like terminals of a battery cell subgroup, collector plates 140A and 140H connect with module-level output terminals 142A and 142B, respectively.

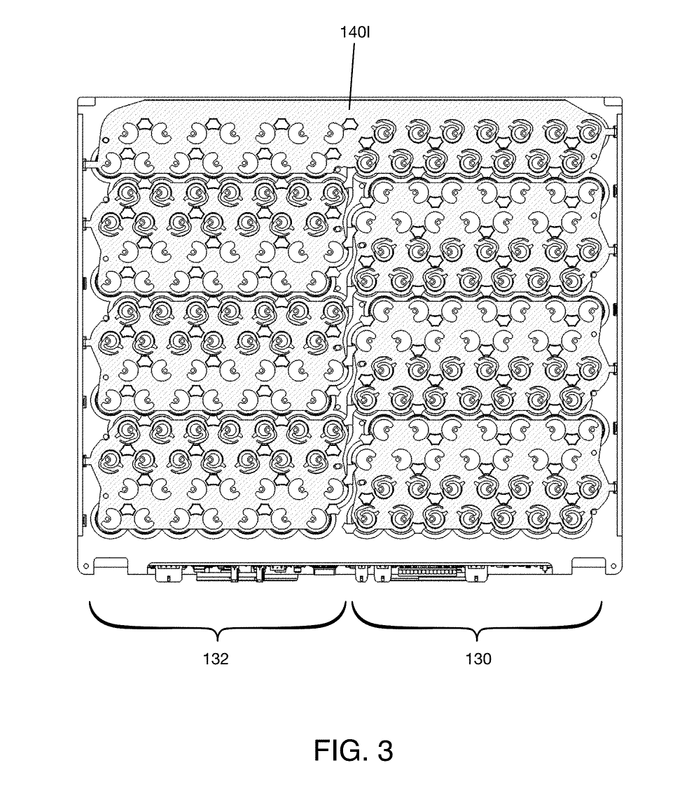

The bottom side of module 110 is illustrated the bottom plan view of FIG. 3. The bottom side is generally analogous to the top side, with each cell's opposite polarity terminal exposed thereon and connected with a collector plate. However, the bottom side further includes a bridge collector plate 1401, spanning left-side cell group 130 (specifically, subgroup 130G) and right-side cell group 132 (specifically, subgroup 132A). The bridge collector plate 1401 provides, amongst other things, module-level safety features, as described further below.

Amongst the important functions that may be desirable in a battery pack such as those illustrated in FIGS. 1-3 are monitoring of voltage and temperature levels across various portions of the module. Temperature transducers and voltage measuring sensors may be mounted at various positions within the battery module, and connected via wiring to a central control circuit. However, assembling such mechanisms via wiring may require complex and costly assembly techniques. Complex wiring connections may suffer from reliability limitations, particularly in harsh physical environments such as may be commonly experienced by electric powered vehicles.

For these and other reasons, in some embodiments, battery module sensing assemblies may be formed from flexible printed circuits (FPCs). A limited number of previously-manufactured, FPCs may be quickly attached to a battery module and interconnected in order to provide extensive monitoring capabilities across the battery module, in a highly reliable and easily-manufactured assembly adding minimal size to the module.

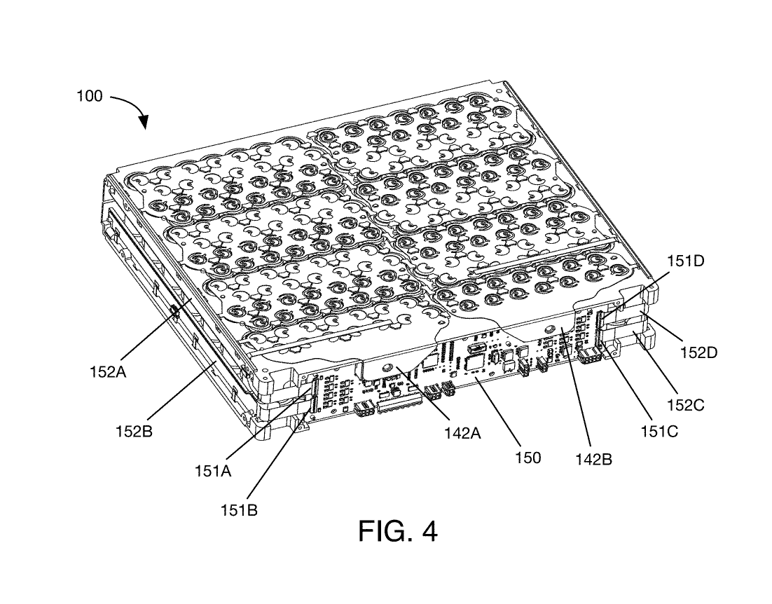

FIG. 4 illustrates a perspective view of a battery module with a sensing assembly formed from FPCs. The terms “FPC” or “flexible printed circuit” as used herein are generally intended to refer to a class of circuit electronics in which conductors and other circuit elements may be mounted on, or embedded within, in a thin flexible substrate. For example, a FPC may be formed by photolithographic printing of conductive copper traces on a plastic (e.g. polyimide) film substrate, with exposed conductor pads providing opportunities for mounting of electronic components and/or interconnecting the FPC with other circuits.

The embodiment of FIG. 4 includes a central battery management circuit board 150. Battery management board 150 may be comprised of a rigid, potentially multi-layer printed circuit board mounted to or proximate one side of module 100. Preferably, battery management board 150 is mounted to a front surface of module 100, on which module output terminals 142A and 142B may also be provided. Battery management board 150 may include a battery management circuit for monitoring and controlling the battery module operation, including voltage monitors for tracking voltage levels at various points within the battery module (e.g. at each collector plate and at battery module output terminals) and temperature monitoring circuits for tracking temperature at various points within and/or outside the battery module.

Battery management board 150 includes multiple flexible printed circuit (FPC) connectors 151A, 151B, 151C and 151D. During module assembly, a side flexible printed circuit assembly 152 is inserted into each FPC connector 151. In the embodiment of FIG. 4: upper left side FPC 152A is inserted into FPC connector 151A; lower left side FPC 152B is inserted into FPC connector 151B; lower right side FPC 152C is inserted into FPC connector 151C; and upper right side FPC 152D is inserted into FPC connector 151D. Side FPC assemblies 152 preferably include self-stick adhesive on one side, such that during assembly, they may be inserted into a FPC connector 151, wrapped tightly around to another side of module 100, and adhered in place as illustrated in FIG. 4. This structure wraps a large-format battery module in conductive pathways for precise voltage and temperature monitoring distributed across the module, while still providing for simple, quick and reliable module assembly with a low part count.

For voltage monitoring, module collector plates may be connected directly to side FPCs 152. In particular, each collector plate includes a voltage monitoring tab extending laterally outwards from the side of module 100. Prior to or during assembly, the voltage monitoring tab may be bent approximately 90 degrees towards the module centerline (i.e. tabs on top side collect plates are bent downwards; tabs on bottom side collector plates are bent upwards), forming a perpendicular extension from the collector plate body which overlies conductor pads that are exposed on the side FPCs. The collector plate voltage monitoring tabs may then be soldered directly to the side FPCs. Conductive traces within side FPCs 152 connect the voltage monitoring tabs with voltage measuring circuitry (which may be situated on battery management board 150 or elsewhere), thereby providing a structural assembly enabling monitoring of voltage levels on each collector plate without wiring assemblies, and with a minimal number of components and minimal assembly effort.

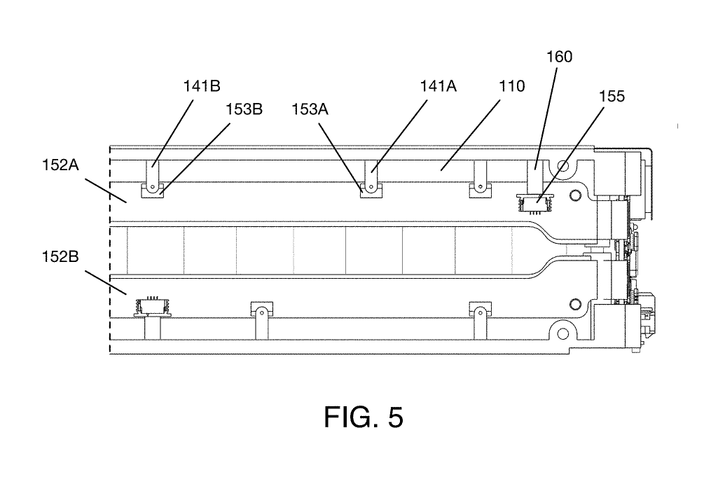

FIG. 5 provides a partial cutaway elevation of module 100 with side FPCs 152A and 152B installed on a side surface of battery retention frame 110. Regarding upper FPC 152A, voltage monitoring tabs 141A and 141B extending from top side collector plates overlap, and are soldered to, FPC conductor pads 153A and 153B, respectively. FPC pads 153 are each connected to battery management board 150 via internal traces within FPC 152A and FPC connector 151A. Lower FPC 152B is similarly connected with bottom side collector plates.

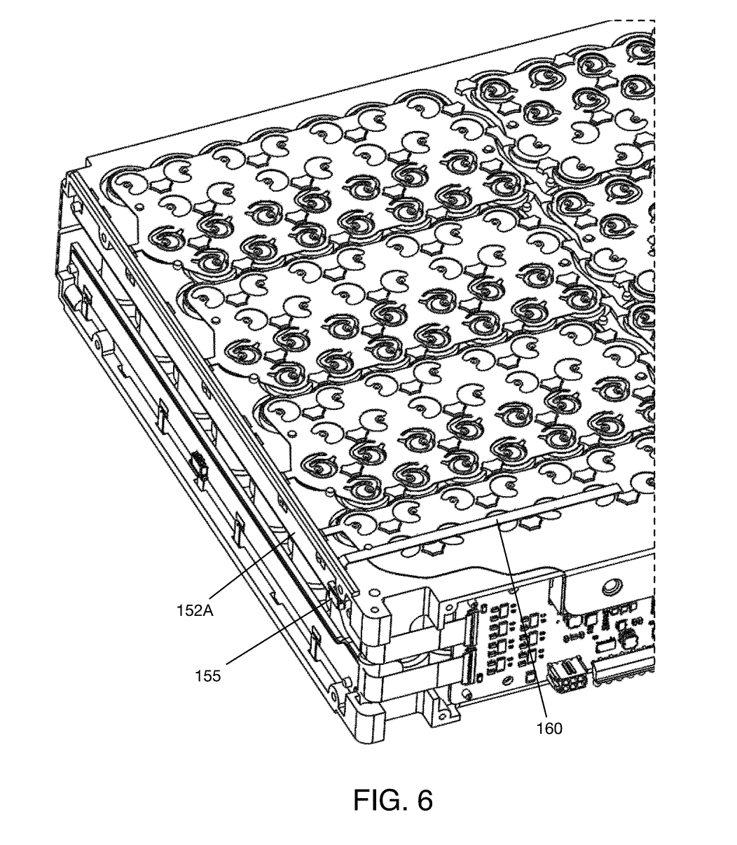

While side FPC assemblies 152 may provide effective structures for distributed collector plate voltage monitoring, flexible printed circuit structures may also be utilized for temperature monitoring at locations distributed throughout large format battery module 100. To that end, in some embodiments, each flexible printed circuit assembly secured to the battery module side surface may interconnect with one or more branch flexible printed circuit assemblies that extend across the top and/or bottom sides of the battery module. Such an arrangement is illustrated in FIG. 4, and in further detail in the partial cutaway upper perspective view of FIG. 6. Upper left side flexible printed circuit 152A includes FPC connector 155 along its length. Connector 155 is oriented with a receptacle facing outwards (i.e. for FPC 152A, towards the top side of module 100), proximate the outer flexible printed circuit edge. During module assembly, branch FPC 160 can then be inserted into connector 155, and wrapped around the top side of module 100 and over the collector plates. Varying numbers of branch FPCs may be distributed at various positions along the length of a sensing FPC 152, to accommodate differing design objectives with regard to the portions of module 100 for which temperature sensing is desired.

One or more temperature sensors may be provided directly on each branch FPC 160, with FPC conductive traces connecting each sensor to associated monitoring circuitry within module 100. The temperature monitoring circuitry may then be centrally located on battery management board 150, or distributed over various structures and locations. For example, if temperature monitoring circuitry is centralized on battery management board 150, signals from temperature monitors installed on a branch FPC 160 may be conducted through branch FPC 160, FPC connector 155, a side FPC 152 and a FPC connector 15, to battery management board 150.

Like side FPCs 152, branch FPCs 160 may be attached by adhesive, such as tape-over adhesive or contact adhesive on one side of each branch FPC 160. After insertion into an FPC connector 155, a branch FPC 160 may be wrapped around a corner to the top or bottom side of module 100 and adhered to a collector plate 140, thereby enabling rapid and reliable assembly.

The embodiment of FIGS. 4-6 utilizes multiple flexible PCB sensing assembly components that are generally linear in shape and joined together during module assembly. It is contemplated and understood that in other embodiments, one or more of the side PCBs, top side sensing extensions and bottom side sensing extensions may all be formed from a single integrated flexible printed circuit component, thereby further reducing assembly requirements during battery module manufacture.

However, use of linear, modular, interconnected FPCs can facilitate high density printing of PCB components on a flexible PCB substrate during manufacturing, thereby minimizing manufacturing costs. Also, various parts (e.g. the top-side and bottom-side sensing extensions) can be reused across numerous different battery module geometries and configurations. For example, different module voltage and current capacities may be configured within a given clamshell by modifying the cell polarity pattern; such a reconfiguration may be achieved by using differently-sized collector plates and different side FPCs having voltage sensing pads to match the location of collector plate voltage monitoring tabs, while maintaining a common clamshell and top/bottom FPC extensions. As a result, differently-configured battery modules may be manufactured without, e.g., reprogramming a wiring machine or retraining wiring personnel.

Because flexible printed circuits are extremely thin in profile, they may be distributed around module 100 while adding negligible height. As a result, the height of an assembled battery module may be maintained very close to the height of the battery cells themselves. Such use of FPCs also avoids pinched wiring and other potential manufacturing defects.

In other embodiments, module assembly may be streamlined even further by utilizing a PCB sensing assembly that is positioned centrally in the module, rather than assemblies that are wrapped around the module sides. In particular, a centrally-positioned PCB assembly may be utilized, as described hereinbelow.

Because common battery cells are cylindrical in shape, large format battery modules designed for high energy density may beneficially utilize a staggered cell layout, where adjacent rows of cells are offset from one another, typically such that the center of cells in a first row are offset half way between two cells in an adjacent row. Such a cell layout may minimize space requirements for a given number of cells, and is illustrated, for example, in the embodiment of FIG. 1. In such an embodiment, left cell group 130 may be slightly spaced from right cell group 132, forming a central spacing channel between them. Such spacing may, for example, reduce risk of short circuiting between two cell groups with high voltage differential, and/or provide opportunities for thermal relief.

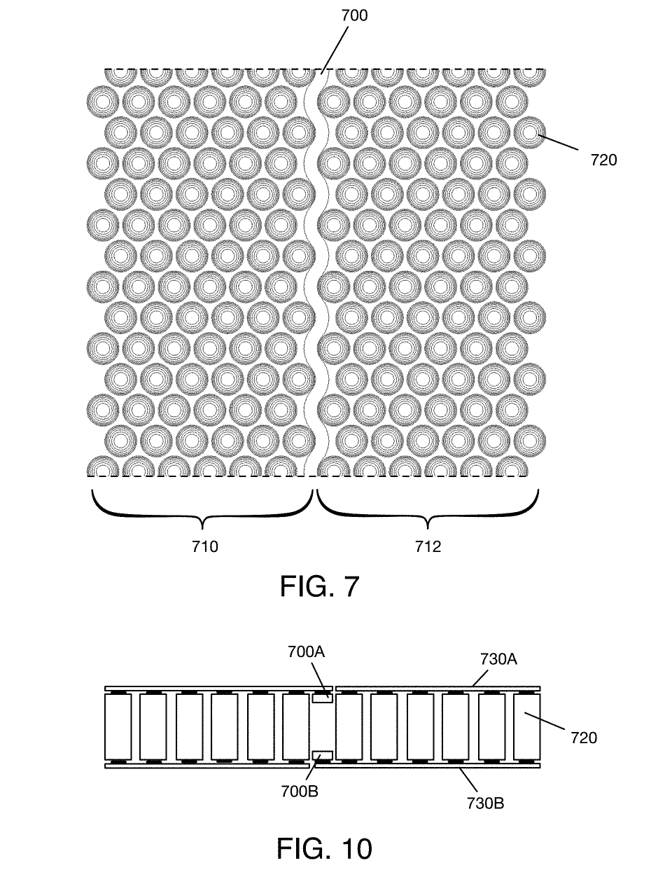

Additionally, spacing provided between left and right cell groups may be utilized to incorporate a central PCB assembly for voltage and/or temperature monitoring. FIG. 7 illustrates such an arrangement in top plan view. A PCB sensing assembly 700 is manufactured having a shape configured to fit through a central channel in between left cell group 710 and right cell group 712. With the cell configuration illustrated, with staggered offset rows of cylindrical cells, PCB 700 is manufactured to have a serpentine shape, when viewed from above, thereby allowing PCB 700 to sit down between cells 720, while still providing sufficient PCB area to incorporate a relatively large number of conductive traces utilizing relatively inexpensive PCB manufacturing processes.

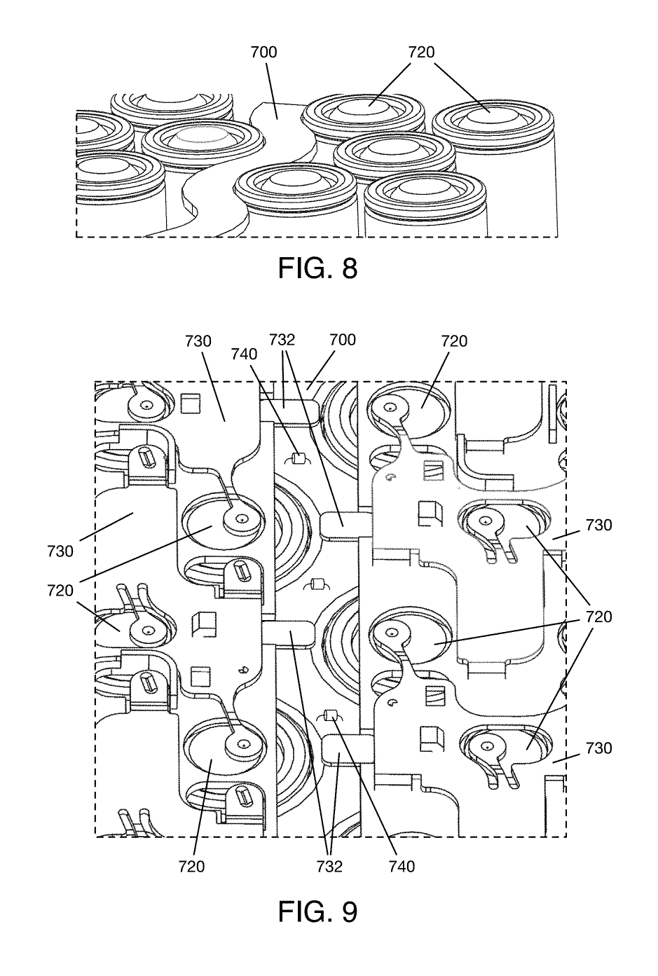

By configuring serpentine PCB 700 to fit down between cells 720, the sensing assembly may span the length of a battery module, while facilitating simple electrical interconnects with overlying collector plates—all of which may be accomplished without appreciably increasing the assembled height of the battery module, thereby preserving module energy density, particularly in applications in which multiple modules are stacked for form a larger format battery pack. In some embodiments, PCB 700 may substantially fill (when viewed from above or below) the central spacing channel between the left side and right side cell groups, potentially maximizing available PCB space to run conductive traces. FIG. 8 is a partial cutaway top perspective view of the arrangement of FIG. 7, showing the vertical positioning of PCB 700 relative to cells 720. Preferably, PCB 700 is supported by an underlying cell retaining frame (not shown in FIG. 8) such that the elevation of the outermost surface of PCB 700 is proximate to the elevation of an end of each cell 720.

FIG. 9 is a partial cutaway top perspective view of a portion of a battery module, with collector plates installed overlying cells 720 and serpentine sensing PCB 700. Upon assembly of the battery module, serpentine PCB 700 rests just below overlying collector plates 730, such that the inclusion of PCB 700 does not act to increase the overall height of the battery module. Meanwhile, each collector plate 730 includes a connecting tab 732. Connecting tabs 732 extend towards the module centerline, each overlying a portion of serpentine PCB 700 at which a steel solder pad is provided. By utilizing a steel solder pad, connecting tabs 732 may then be easily connected to PCB 700 using the same attachment process, and potentially the same assembly station, utilized to connect the collector plates with cells 720 (which typically have steel end electrodes), thereby simplifying, automating and speeding assembly. Exemplary techniques for connecting a collector plate 730 to PCB 700 (and cells 720) include, without limitation, resistance welding and laser welding.

PCB 700, as illustrated in FIG. 7-9, provides a single PCB sensing assembly with direct electrical connections to each collector plate 730, thereby facilitating independent monitoring of voltage levels on each collector plate on a given side of the battery module (i.e. either top side collector plates or bottom side collector plates). The opposite side of the battery module may be constructed similarly, with a centrally-positioned serpentine PCB installed just inside a series of collector plates for direct connection thereto. For example, FIG. 10 illustrates an exemplary embodiment having cells 720, top collector plates 730A, bottom collector plates 730B, a top monitoring PCB 700A, and a bottom monitoring PCB 700B in a schematic a cross-sectional slice elevation view.

In some embodiments, sensing PCB 700 may also include one or more thermistors (or other temperature sensors) 740, as illustrated in FIG. 9. In such embodiments, the outputs of thermistors 740 are conveyed through PCB 700 to a monitoring circuit, such as battery management board 150, described further below. Thermistors 740 may therefore be used to collect bulk temperature data descriptive of cells operating in the general vicinity of the thermistor, without requiring installation of additional components during module assembly.

In some embodiments, voltage monitoring and/or temperature monitoring circuitry may be provided directly on sensing PCB assembly 700. In other embodiments, PCB 700 may be utilized to conduct voltage levels received from each collector plate, and/or temperature sensor outputs, to a common battery monitoring circuit, such as battery management board 150 in the embodiment of FIG. 4. In such embodiments, separate top side and bottom side instances of sensing PCB 700 may convey all sensing signals to a single monitoring circuit on battery management board 150. PCBs 700 may interconnect with battery management board 150 via mechanisms including, without limitation, a short length of flexible PCB running between PCB 700 and battery management board 150, direct board-to-board connectors, or cabling.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

What is claimed is:

1. A battery module comprising:
a plurality of battery cells within a cell retention frame;
a plurality of collector structures, each collector structure electrically interconnecting a plurality of said battery cells proximate a top side or bottom side of said cell retention frame;
a battery management circuit comprising a voltage monitor; and
one or more monitoring flexible printed circuits (FPCs), each monitoring FPC electrically interconnecting the battery management circuit with one or more of the collector structures.

2. The battery module of claim 1, in which:
the battery module has a top surface, a bottom surface, and a plurality of side surfaces; and
the one or more monitoring FPCs comprise:
one or more left side monitoring FPCs mounted proximate a left side surface of said battery module; and
one or more right side monitoring FPCs mounted proximate a right side surface of said battery module.

3. The battery module of claim 2, in which:
the collector structures comprise a plurality of top side collector plates each overlying a top side of a subset of said cells, and a plurality of bottom side collector plates each overlying a bottom side of a subset of said cells;
the one or more left side monitoring FPCs comprise:
a top left monitoring FPC positioned along the battery module left side proximate the top surface of the battery module, the top left monitoring FPC electrically interconnected with one or more of said top side collector structures, and
a bottom left monitoring FPC positioned along the battery module left side proximate the bottom surface of the battery module, the bottom left monitoring FPC electrically interconnected with one or more of said bottom side collector structures;
and wherein the one or more right side monitoring FPCs comprise:
a top right monitoring FPC positioned along the battery module right side proximate the top surface of the battery module, electrically interconnected with one or more of said top side collector structures, and
a bottom right monitoring FPC positioned along the battery module right side proximate the bottom surface of the battery module, electrically interconnected with one or more of said bottom side collector structures.

4. The battery module of claim 2, in which the one or more monitoring FPCs each comprise adhesive applied to one side thereof, for adhering said monitoring FPC to the cell retention frame.

5. The battery module of claim 2, in which the battery management circuit comprises a printed circuit board mounted to a front side surface of the cell retention frame.

6. The battery module of claim 2, further comprising:
a plurality of top side collector plates, each contacting a subset of the battery cells proximate the battery module top surface;
a plurality of bottom side collector plates, each contacting a subset of the battery cells proximate the battery module bottom surface; and
wherein each collector plate is electrically interconnected with one of said monitoring FPCs.

7. The battery module of claim 6, in which each collector plate is electrically interconnected with one of said monitoring FPCs via an electrical interconnect comprising a voltage monitoring tab formed by one of said collector plates and extending towards a battery module side surface, the voltage monitoring tab being soldered to one of said monitoring FPCs.

8. The battery module of claim 7, in which said voltage monitoring tab is bent approximately 90 degrees towards a battery module centerline, such that a portion of said voltage monitoring tab is approximately parallel with a battery module side surface.

9. The battery module of claim 1, further comprising a plurality of temperature monitoring extensions, each temperature monitoring extension comprising a flexible printed circuit and electrically connected with one of said monitoring FPCs.

10. The battery module of claim 9, in which each temperature monitoring extension is connected to a monitoring FPC via a flexible printed circuit connector.

11. The battery module of claim 9,
further comprising: a plurality of top side collector plates, each electrically interconnected with a subset of the battery cells proximate the battery module top surface; and a plurality of bottom side collector plates, each electrically interconnected with a subset of the battery cells proximate the battery module bottom surface; and
in which each temperature monitoring extension wraps around the cell retention frame and over one or more of said top side collector plates and/or said bottom side collector plates.

12. The battery module of claim 9, in which each temperature monitoring extension comprises a temperature sensor; and in which the plurality of temperature monitoring extensions are distributed over the cells proximate the top and bottom surfaces of the battery module.

13. The battery module of claim 9, in which each temperature monitoring extension overlies one or more of said battery cells.

14. A battery module comprising:
a plurality of cylindrical battery cells within a cell retention frame, the battery cells arranged in staggered offset rows with a central spacing channel through a central portion of the battery module separating a left side cell group and a right side cell group;
a plurality of top side collector structures, each top side collector structure electrically interconnecting a plurality of said battery cells proximate a top side of said cell retention frame;
a battery management circuit comprising a voltage monitor; and
a serpentine top side monitoring printed circuit board (PCB), the top side monitoring PCB: mounted to the cell retention frame within the central spacing channel, inside the top side collector structures; and electrically interconnecting the plurality of top side collector structures with the battery management circuit.

15. The battery module of claim 14, in which the plurality of top side collector structures each comprise a collector plate having a voltage monitoring tab portion extending over a portion of the top side monitoring PCB, and electrically interconnected therewith.

16. The battery module of claim 15, in which the top side monitoring PCB comprises a steel pad underlying each voltage monitoring tab; and wherein each voltage monitoring tab is electrically interconnected with said underlying steel pad.

17. The battery module of claim 16, in which each voltage monitoring tab is electrically interconnected with said underlying steel pad using a common welding process also utilized to electrically interconnect said top side collector structures with said plurality of battery cells.

18. The battery module of claim 14, further comprising:
a plurality of bottom side collector structures, each bottom side collector structure electrically interconnecting a plurality of said battery cells proximate a bottom side of said cell retention frame; and
a bottom side serpentine monitoring printed circuit board (PCB), the bottom side monitoring PCB: mounted to the cell retention frame within the central spacing channel, inside the bottom side collector structures; and electrically interconnecting the plurality of bottom side collector structures with the battery management circuit.

19. The battery module of claim 18, in which one or more of the monitoring PCBs further comprises one or more temperature sensors electrically interconnected with the battery management circuit via said monitoring PCB.

20. The battery module of claim 18, in which said top side monitoring PCB and said bottom side monitoring PCB each substantially fill the central spacing channel.
